(19) United States
(12) Patent Application Publication
(10) Pub. No.: US 2008/0008848 A1
(43) Pub. Date: Jan. 10, 2008

(54) Multi-Layer Material, Especially for Packaging Oxygen-Sensitive Products

(75) Inventors: Stefan Dick, Weichering (DE); Inge Kramer, Freising (DE); Gertraud Goldhan, Moosburg (DE); Norbert Rodler, Zolling (DE); Thomas Hubensteiner, Freising (DE); Cornelia Stramm, Munchen (DE); Klaus Rieblinger, Hallbergmoss (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignees: SUD-CHEMIE AG, Munchen (DE); FRAUNHOFER-GESELLSCHAFT ZUR FORDERUNG DER ANGEWAND, Munchen (DE)

(21) Appl. No.: 11/579,516

(22) PCT Filed: May 3, 2005
(86) PCT No.: PCT/EP05/04784

§ 371 Date: Jan. 12, 2007

(30) Foreign Application Priority Data
May 3, 2004 (DE) 10 2004 021 632.0
Dec. 23, 2004 (DE) 10 2004 062 204.3

(51) Int. Cl. B32B 27/00; B65D 65/40

(52) U.S. Cl. 428/35.8; 264/512; 264/514; 428/214; 428/216; 428/351; 428/355 R

(57) ABSTRACT

The present invention relates to a multilayer material comprising at least the following sequence of layers: a) a gas-barrier layer based on EVOH; b) an adhesion-promoter layer based at least one anhydride-modified polymer; c) an oxygen-absorber layer composed of at least one polymeric, non- particulate oxygen absorber, where the total thickness of the adhesion-promoter layer(s) is preferably at least approximately 10 μm, and also to a process for their production, and to their use.

The invention relates to multilayer materials, in particular multilayer packaging materials for oxygen-sensitive products. The inventive materials are particularly suitable for production of blister packs for pharmaceutical and other products. Further aspects of the invention relate to a process for production of these multilayer materials, and also to their preferred uses.

Packaging which provides a barrier with respect to oxygen or provides protection from oxygen has hitherto been marketed exclusively for food or drink. The prior art describes mono- and multilayer foils into which oxygen absorbers have been integrated for protection of contents susceptible to oxidation, examples being found in U.S. Pat. No. 5,350,622; EP.0 888′719, WO 95 11801 and WO 02 44034. The oxygen absorber can either have been incorporated into one layer of the multilayer system or else can be present in the form of a separate layer in the multilayer system. The multilayer foils described hitherto, known mainly in the food-and-drink industry, generally comprise iron-based oxygen absorbers. However, these do not react until moisture is present, often have undesirable color, and exhibit slow oxygen absorption and low capacity, particularly when relative humidity is low. Another disadvantage is that the barrier properties of the known packaging materials for sensitive pharmaceutical products, particularly with respect to oxygen, are mostly inadequate. Furthermore, the known packaging materials are frequently complicated to produce and have unsatisfactory processing properties, such as thermoformability, adequacy of adhesion between the individual layers, transparency of the multilayer systems, or activatability of the oxygen absorber.

Multilayer foils can be produced via coextrusion and/or lamination. In principle, multilayer-packaging foils and packaging materials for sensitive goods are composed of a thin gas-barrier core layer, which may have been bonded by way of an adhesion-promoter layer or a lamination-adhesive layer to outer layers. U.S. Pat. No. 6,589,384 B2 and U.S. Pat. No. 6,462,163 B2 relate to certain solvent-free polyurethane adhesive layers, where the coating weights stated imply layer thicknesses well below 5 μm.

It was therefore an object of the present invention to provide a multilayer material which eliminates the disadvantages of the prior art, provides very good barrier properties, and also at the same time can be produced easily and rapidly and can be processed particularly advantageously to give blister packs. Another object was provision of a multilayer material with good oxygen-absorption properties.

These objects are achieved via the multilayer materials as claimed in claim 1. The subclaims state advantageous embodiments.

Within the present invention it has unexpectedly been found that particularly advantageous multilayer materials with excellent barrier properties, in particular with low moisture permeability and low oxygen permeability, and with active oxygen absorption, can be obtained if the multilayer material comprises at least the following sequence of mutually adjoining layers:
a) a gas-barrier layer based on EVOH;
b) an adhesion-promoter layer based on at least one anhydride-modified polymer;
c) an oxygen-absorber layer based on at least one polymeric, non-particulate oxygen absorber.

This layer sequence provides, inter alia, an unexpected improvement in the gas barrier, in particular for oxygen, but also for other gases, such as CO₂ or moisture. An important factor here is that an adhesion-promoter layer based on an anhydride-modified polymer has been arranged between the gas-barrier layer, comprising or based on EVOH, and the oxygen-absorber layer based on at least one polymeric, non-particulate oxygen absorber. Without any intention to limit the invention to the correctness of this assumption, it is believed that when the present layer sequence is used the properties obtained from the materials at the contact surfaces of the layers or in the layers themselves differ from those of the individual layers per se and interact to give a surprisingly increased level of barrier properties. This was all the more surprising because by way of example WO 02/44034 A2 expressly teaches the direct bonding of a EVOH oxygen-barrier layer and an oxygen-absorber layer with an ethylenically unsaturated polymeric oxygen absorber.

It has also been found, surprisingly, that when materials other than those defined herein are used for the above layers adhesion-promoter layer it is not possible to achieve such advantageous interaction of the abovementioned layers for the barrier properties of the multilayer material.

According to the invention, therefore, a layer based on an adhesion promoter in the form of an anhydride-modified polymer is used as adhesion-promoter layer between the gas-barrier layer and the oxygen-absorber layer. Surprisingly, it was then found that particularly good barrier properties, particularly with respect to oxygen and other gaseous substances, such as carbon dioxide, are obtained if the adhesion promoter has been selected from anhydride-modified polyolefins, in particular anhydride-modified polyethylene or polypropylene. These anhydride-modified polymers and, respectively, polyolefins are well known per se to the person skilled in the art. The examples state non-limiting examples of suitable adhesion promoters. When these adhesion promoters are used in the inventive multilayer materials, particularly good processibility and bond strength was also observed.

The meaning of the expression “based on” in the present description comprises “composed of” “in essence composed of”, or “comprising”. The appropriate layer preferably has more than 50% of the respectively stated components, particularly preferably at least 75%, in particular at least 90%.

In one preferred embodiment of the invention, the adhesion-promoter layer is composed mainly, i.e. to an extent of more than 50% by weight, of at least one adhesion promoter. Further preference is given to a proportion of more than 75% by weight, in particular more than 90% by weight. It was then found that the level of barrier properties increases with the proportion of the adhesion promoter (over the anhydride-modified polymer) in the adhesion-promoter layer. Particularly advantageous results are obtained if the adhesion-promoter layer is composed of more than 95% by weight of the abovementioned adhesion promoter, in particular more than 99% by weight. In one particularly preferred embodiment of the invention, the adhesion-promoter layer is therefore composed in essence or exclusively of at least one adhesion promoter in the form of one or more anhydride-modified polymers.

The gas-barrier layer adjoining one side of the adhesion-promoter layer comprises, or is based according to the invention on, EVOH (ethylene-vinyl alcohol copolymer). A gas-barrier layer here preferably means a layer which provides a considerable barrier function for gaseous substances, in particular oxygen and carbon dioxide. The transmission of this layer should be <10 cm³/m²dbar for foils of thickness 100 μm in accordance with the barrier systems familiar to the person skilled in the art. Here again, it has been found that the level of barrier properties rises with the proportion of EVOH, in particular in association with the adjoining adhesion-promoter layer and the oxygen-absorber layer. In one preferred embodiment of the invention, the gas-barrier layer is composed mainly, i.e. to an extent of more than 50% by weight, of EVOH. Further preference is given to a proportion of more than 75% by weight, in particular more than 90% by weight. Particularly advantageous results are obtained if the gas-barrier layer is composed of more than 95% by weight of EVOH, particularly more than 99% by weight. In one particularly preferred embodiment of the invention, the gas-barrier layer is therefore composed in essence or exclusively of EVOH.

However, in a further embodiment of the invention, not only EVOH but also polyamide can be present in the gas-barrier layer. In particular, a layer composed of EVOH can have been provided on one or both sides with a separate layer composed of polyamide. It has been found that this method permits production of foils/layers which are less expensive but in many cases practically equivalent when comparison is made with gas-barrier layers composed entirely of EVOH. Accordingly, in one embodiment of the invention an EVOH layer, as gas-barrier layer, has been provided with an adjoining layer composed of polyamide, on the side opposite to the adhesion-promoter layer.

According to the invention, the oxygen-absorber layer adjoining the other side (generally the subsequent contents side) of the adhesion-promoter layer is based on at least one polymeric, non-particulate oxygen absorber. It has thus been found that non-polymeric oxygen absorbers cannot achieve equivalent results. “Polymeric” is intended here particularly to mean homopolymeric, copolymeric, and terpolymeric compounds, and higher-order polymeric compounds. The term “polymeric” is also intended to provide demarcation with respect to “monomeric” or “non-polymeric”. Though there is no intention to limit the invention to the correctness of this assumption, it is assumed that polymeric oxygen absorbers permit particularly advantageous interaction with the adjacent adhesion-promoter layer based on at least one anhydride-modified polymer. It also appears that particulate oxygen absorbers disrupt this advantageous interaction with the adjacent adhesion-promoter layer. It is therefore preferable that the oxygen-absorber layer comprise no particulate components.

Here again, it has been found that the level of barrier properties rises with the proportion of the oxygen absorber, particularly in association with the adjoining adhesion-promoter layer and the gas-barrier layer. In one preferred embodiment of the invention, the oxygen-absorber layer is composed mainly, i.e. to an extent of more than 50% by weight, of the abovementioned oxygen absorber. Further preference is given to a proportion of more than 75% by weight, particularly more than 90% by weight. Particularly advantageous results are obtained when the oxygen-absorber layer is composed of more than 95% by weight of the abovementioned oxygen absorber, particularly more than 99% by weight. In one particularly preferred embodiment of the invention, the oxygen-absorber layer is therefore composed in essence or exclusively of the abovementioned oxygen absorber. The catalyst for the reduction of the oxygen absorber, particularly a transition metal catalyst, e.g. as known to the person skilled in the art from WO02/44034, can optionally be present, as also can a photoinitiator and, if appropriate, an antioxidant.

Particular inventive preference is given to ethylenically unsaturated polymeric oxygen absorbers. Examples of suitable polymeric oxygen absorbers are the low-molecular-weight ethylenically unsaturated compounds, such as polybutadiene oligomer or polybutadienediols, as described in WO99/15433 A, catalyst-free absorbers, such as quinones, photoreducible dyes and carbonyl compounds, in particular anthraquinones, as described in WO96/34070 and WO94/12590, aliphatic hydrocarbons having at least one unsaturated group and/or at least one unsaturated fatty acid compound, and also systems composed of polydienes, or polyethylene-butylene copolymers as described in EP 0 835 685 and EP 0 965 381, and oxidizable polydienes or polyethers as described in WO01/83318. The disclosures in this connection are expressly incorporated into the description by way of reference.

Surprisingly, the best results were obtained with a polymeric oxygen absorber or an “oxygen scavenging layer” as claimed in WO02/44034. The description of WO02/44034 in this connection is therefore expressly incorporated into the present description by way of reference. In brief, therefore, the preferred oxygen-absorber layer comprises
a polymer having an ethylenic backbone and having a cycloalkenyl group having the following structure I: 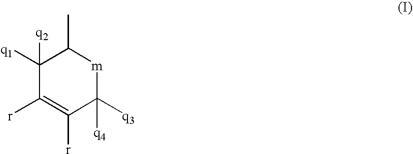
in which q₁, q₂, q₃, q₄, and r, independently of one another, have been selected from hydrogen, methyl, or ethyl; m is —(CH₂)ₙ—, in which n is a whole number from 0 to 4 (inclusive), and, if r is hydrogen, at least one of q₁, q₂, q₃, and q₄ is also hydrogen. The oxygen absorber is preferably an ethylene-vinylcyclohexene copolymer (EVCH). The oxygen-absorber polymer preferably moreover has a connecting group which bonds the ethylenic backbone to the cyclic olefin group. The connecting group has been selected from
—O—(CHR)ₙ—; —(C═O)—O—(CHR)ₙ—; —NH—(CHR)ₙ—; —O—(C═O)—(CHR)ₙ—; —(C═O)—NH—(CHR)ₙ—; or —(C═O)—O—CHOH—CH₂—O—.

The cyclic olefin group is preferably a cycloalkenyl group having the structure I. It is further preferable that, in the structure I, n is equal 1, and each of q₁, q₂, q₃, q₄, and r is hydrogen. It is still further preferable that the oxygen- absorber polymer is a cyclohexenylmethyl acrylate homopolymer (CHAA), a cyclohexenylmethyl acrylate copolymer, a cyclohexenylmethyl methacrylate homopolymer (CHMA), a cyclohexenylmethyl methacrylate copolymer, or a mixture composed or more than one of the above components. The oxygen-absorber polymer is most preferably an ethylene-methyl acrylate-cyclohexenylmethyl acrylate copolymer (EMCM). The oxygen-absorber layer can comprise not only the abovementioned catalyst but also at least one photoinitiator and, if appropriate, at least one antioxidant, as is familiar to the person skilled in the art and described by way of example in WO 02/44034 A2. The disclosure of WO 02/44034 in this connection is likewise expressly incorporated into the present description by way of reference.

Another surprising finding which is particularly preferable and advantageous in combination with the above layer sequence within the present invention is that particularly advantageous multilayer materials with excellent gas- or moisture-barrier properties can be obtained when the total thickness of the adhesion-promoter layer(s) present in the multilayer material is at least approximately 10 μm. Surprisingly, a simultaneous result was particularly good processibility of the inventive multilayer material, for example in the thermoforming process required for production of numerous types of packaging, such as blister packs.

One or more adhesion-promoter layers can be present in the inventive multilayer materials. If two or more adhesion-promoter layers are present, the total thickness of the adhesion-promoter layers is preferably at least approximately 10 μm.

In one preferred embodiment of the invention, the total thickness of the adhesion-promoter layer(s) is at least approximately 15 μm, in particular at least approximately 20 μm. In many cases, preference is given to a total thickness of the adhesion-promoter layer(s) of from approximately 20 to 40 μm, in particular approximately 20 μm, especially when the inventive layer material is intended for use as thermoformable multilayer foil.

In one particularly preferred embodiment of the invention, an adhesion-promoter layer is present whose thickness is at least approximately 5 μm, preferably at least approximately 6 μm, particularly preferably at least approximately 8 μm. In some cases, there is particularly advantageously at least one adhesion-promoter layer whose thickness is at least approximately 10 μm, in certain cases indeed at least approximately 15 μm. The entire multilayer material preferably comprises, as a function of the other layers present, from one to three adhesion-promoter layers. In one preferred embodiment of the invention, therefore, it has been found that a particularly high level of gas barriers and moisture barriers is obtained when the thickness-of the adhesion-promoter layer (b) situated between the gas-barrier layer (a) and the oxygen-absorber layer (c) is at least 5 μm, particularly at least 10 μm, more preferably at least 15 μm, more preferably at least 20 μm.

As stated above for the adhesion-promoter layer arranged between the gas-barrier layer and the oxygen-absorber layer, it is generally preferable that the adhesion-promoter layers are composed mainly, i.e. to an extent of more than 50% by weight, of at least one adhesion promoter. A proportion of more than 75% by weight, particularly preferably more than 90% by weight, will frequently provide particularly advantageous results. The adhesion-promoter layer(s) can thus preferably be composed in essence or exclusively of at least one adhesion promoter.

In an alternate embodiment of the invention, however, it is also possible that at least one adhesion-promoter layer, in particular any adhesion-promoter layer not arranged between the gas-barrier layer and the oxygen-absorber layer, comprises a mixture of an adhesion promoter with at least one other component, where the proportion of the adhesion promoter in the mixture can even be less than approximately 50% by weight. However, the proportion of the adhesion promoter in the mixture is generally at least approximately 10% by weight.

The selection of the other component(s) in the adhesion-promoter layer can by way of example be such that they perform further useful functions in the multilayer material, for example as gas barrier or moisture barrier or oxygen absorber (see below).

As stated above, it has surprisingly been found in the present invention that particularly good barrier properties, in particular with respect to oxygen and other gaseous substances, such as carbon dioxide, are obtained when the adhesion promoter has been selected from anhydride-modified polyolefins, in particular anhydride-modified polyethylene or polypropylene. These anhydride-modified polyolefins are familiar to the person skilled in the art. The examples state non-limiting examples of suitable adhesion promoters. When these adhesion promoters are used in the inventive multilayer materials, particularly good processibility and bond strength was also observed. For any adhesion-promoter layers not arranged between the gas-barrier layer and the oxygen-absorber layer, it is in principle also possible to use other adhesion promoters known to the person skilled in the art. However, preference is again given here to the anhydride-modified polymers.

The coextrusion process therefore uses adhesion promoters which can be melted with various polymers in extruders. The adhesion promoters used inventively preferably involve thermoplastically processible polymers, e.g. ionomeric copolymers, vinyl chloride copolymers, polystyrene copolymers, or anhydride-grafted polymers. Examples are maleic-anhydride- or rubber-modified polymers, such as the Plexar series from Quantum Chemical Corp. In the lamination process, two or more layers are bonded via lamination resins or lamination adhesives. Lamination resins are generally liquid, their polymerization being delayed until a “drying process” takes place. The inventively used lamination adhesives preferably involve polymerizable polyesters, phenolic resins, e.g. from DuPont, or polyurethane systems, these preferably being solvent-free and preferably suitable for foods- or drinks-packaging.

At least one further gas-barrier layer can also be present, if appropriate, in addition to the gas-barrier layer defined above in the multilayer material as claimed in the invention. For this, the constitution of the gas-barrier layer can generally be selected as desired from the materials familiar to the person skilled in the art. The gas-barrier layer is preferably based on polyacrylonitrile (PAN), polyamide (PA), polyethylene halides, such as PVC, PVDC, PVF, PVDF, halogen-containing copolymers, cycloolefinic polymers (COC), polyethylene terephthalate (PET), polycarbonate (PC), EVOH, polyethylene naphthalate (PEN), liquid-crystalline polymers or copolymers (LCP) or inorganic-organic hybrid polymers, or their mixtures or copolymers. It is particularly preferable that there is at least one gas-barrier layer present which is based on EVOH, is in essence composed of EVOH, or is composed entirely of EVOH.

In one preferred embodiment of the invention, the thickness of the gas-barrier layer(s) present in the multilayer material is respectively or in total less than 100 μm, preferably less than 80 μm, in particular less than 50 μm.

In one preferred embodiment of the invention, adhesion-promoter layers have been provided by laterally, respectively adjoining the gas-barrier layer.

In another preferred embodiment of the invention, the multilayer material has at least one outer layer which preferably serves as water-vapor barrier. The term water-vapor barrier is generally used here for materials which transmit less than 10 g/m² d (ISO 15106-3) of water. This outer layer is preferably based on filled or unfilled polymers, in particular selected from polyesters, e.g. polyethylene terephthalate, polyurethanes or polyolefins, such as polyethylene or polypropylene, polyethylene halides, such as PVC, PVDC, PVF, PVDF, halogen-containing copolymers, polyolefin copolymers, such as ethylene-vinyl acetate (EVA), liquid-crystalline polymers (LCPs), PAN, PEN, COC, or their mixtures or copolymers.

The multilayer material as claimed in the invention can also comprise at least one further oxygen-absorber layer in addition to the oxygen-absorber layer defined above. In principle, this can use any desired oxygen absorber. Suitable materials are familiar to the person skilled in the art. A general definition is found by way of example in “Active Food Packaging”, M. L. Rooney, Blackie Academic &Professional, 1995, Chapter 4.

For sachets or labels, use is generally made of oxygen absorbers composed of metal powder, in particular iron, and of a hygroscopic salt, as described in WO 99/47596. In parallel with this, by way of example WO 97/22469 describes the use of linseed oil derivatives, squalene derivatives, or ascorbic acid derivatives. Relatively recent developments are based on low-molecular-weight, ethylenically unsaturated substances as described by way of example in EP 888 719. Both metal powders and, by way of example, ascorbic acid derivatives are activated in the presence of moisture. Relatively recent developments, such as low-molecular-weight, ethylenically unsaturated substances, are generally self-activating and can be used for dry package materials.

Alongside sachets and labels, attempts are increasingly being made to integrate oxygen absorbers into the packaging material, i.e. into the plastic itself. Here, oxygen absorbers are incorporated by mixing into suitable plastics, or are described as a layer in a multilayer structure (U.S. Pat. No. 5,529,833 and WO 97/22469). An example of an application is provided by crown corks for drinks bottles or PET bottles with oxygen-absorbing barrier layer.

Particularly suitable polymeric oxygen absorbers are described by way of example in WO 99/48963, WO 00/00538, WO 94/12590, WO 99/15433, WO 01/83318, and particularly the abovementioned WO02/44034, and the disclosure of these in this connection is hereby incorporated into the description by way of reference.

In one particularly preferred embodiment, the oxygen-absorber layer(s) present in the inventive multilayer material use(s) O₂ absorbers which are self-activating or which can be activated via radiation, such as UV radiation, VIS radiation, X-ray radiation, or γ-radiation, or via water or moisture, or thermally.

Particular preference is given to O₂ absorbers initiated (activated) via UV radiation which also scavenge oxygen at low relative humidity (r.h. <20%); these are particularly suitable for moisture-sensitive pharmaceutical products.

It has unexpectedly been found in the present invention that the structure and the constitution of the multilayer material can provide an excellent barrier function with respect to moisture and oxygen, even superior to that of conventional materials. The inventive packaging materials have a high barrier with respect to O₂ when compared with commonly encountered types of foil whose barrier is termed “high” (<1.0 cm³ O₂/(m² d bar), measured to DIN 53380, part 3, see inventive example 1). In one particularly preferred embodiment of the invention, the oxygen transmission, described in inventive example 1, of the multilayer material is less than 0.1 cm³/(m² d bar). Surprisingly, it has also been found that the invention can also reduce CO₂ transmission to an unexpectedly large extent. For example, in one particularly preferred embodiment of the invention, CO₂ transmission, determined as described in inventive example 1 (DIN 53380 P2 at 23° C.), is <50 cm³/(m² d bar), in particular <25 cm³/(m² d bar), more preferably <10 cm³/(m² d bar), more preferably <5 cm³/(m² d bar), particularly preferably <2 cm³/(m² d bar).

The individual components of the multilayer inventive packaging material here are selected in such a way as to permit production of highly transparent foils which have good thermoforming properties, particularly those desired for production of blister packs for pharmaceutical products.

In one preferred embodiment of the invention, the multilayer materials comprise the following sequence:
a) an outer layer (for the subsequent external side) which preferably serves as water-vapor barrier (see above) and is composed of filled or unfilled polymers, in particular selected from polyester, e.g. polyethylene terephthalate, polyurethanes, polyolefin, such as polyethylene or polypropylene, polyethylene halides, such as PVC, PVDC/ PVF, PVDF, halogen-containing copolymers, polyolefin copolymers, such as ethylene-vinyl acetate (EVA), liquid-crystalline polymers (LCPs), PAN, PEN, COC, or a mixture of these, preferably polyolefins, in particular polyethylenes;
b) an adhesion-promoter layer as defined above, where the adhesion promoter has preferably been selected from: ionomeric copolymers, vinyl chloride copolymers, modified ethylene-vinyl acetates, polymerizable polyesters, phenolic resins, polystyrene copolymers, or anhydride-modified polymers, 2-component adhesives, single-component or two-component lamination resins; PU systems and/or epoxy resins; or a mixture of the above substances, preferably anhydride-modified polymers, solvent-free single-component resins, or isocyanate-free two-component adhesives, in particular anhydride-grafted polyolefins and polyurethane systems;
c) a gas-barrier layer based on EVOH, as defined above;
d) a second adhesion-promoter layer based on an anhydride-modified polymer, as defined above;
e) an oxygen-absorber layer based on at least one polymeric, non-particulate oxygen absorber, as defined above. Because of the advantageous properties of the resultant multilayer packaging material, use is preferably made of, inter alia, the oxygen-absorbent material as claimed in WO02/44034, WO 99/48963 and WO 00/00538.

As stated above, in one preferred embodiment of the invention, the gas-barrier layer can comprise not only ethylene-vinyl alcohol copolymer (EVOH) but also polyamide. One preferred possibility here has a core layer composed of EVOH unilaterally or, particularly preferably, bilaterally surrounded by a layer based on polyamide.

The inventive multilayer materials preferably involve transparent or translucent multilayer foils. In many cases, the total thickness of the multilayer material is at least 100 μm.

Surprisingly, therefore, it has been found in the present invention that the adhesion-promoter layer(s) and the thickness thereof is not only of decisive importance for the adhesion of the adjoining layers, for example of the gas-barrier layer c) to the adjacent layers b) and d), but also has unexpectedly great effect on the barrier properties and processing properties of the multilayer material. Particular preference is given to anhydride-modified polymers, solvent-free single-component resins, or isocyanate-free two-component adhesives, particularly to anhydride-grafted polyolefins. Surprisingly, it is readily possible to initiate the multilayer materials comprising oxygen absorber with a very small dose of UV light when the inventive layer structure is used.

Furthermore, it is surprising that the inventive layer systems with integrated oxygen absorber can readily be activated for oxygen absorption using a very small dose of UW light. When comparison is made with the theoretically achievable oxygen-absorption capacity, the capacity of the inventive packaging materials is surprisingly high (corresponding to from 60-99% of theory), in particular at low relative humidity (e.g. r.h. smaller than approximately 50%, in particular smaller than approximately 25%), particularly when anhydride-modified adhesion promoters are used. The kinetics of oxygen absorption are also comparable with theoretical expectations, whereas this cannot be expected for multilayer systems.

As mentioned above, in one preferred embodiment the inventive multilayer material preferably also has, facing toward the inner side of the packaging (contents side), a further layer (f), in particular an outer layer which by way of example is in contact with the packaged product (contact layer). This outer layer or contact layer has preferably been selected from polyvinyl chloride, polyethylene, or polypropylene. BOPP foils, which are available at comparatively-good prices, can be advantageously processed here in one processing step with the other layers to give the inventive multilayer packaging material. Surprisingly, in one advantageous embodiment of the invention, very good adhesion of the PVC foil with the polymeric oxygen-absorber layer is found with a high level of oxygen scavenging, preferably without the use of conventional single-component adhesives.

As likewise mentioned above, the inventive multilayer material can be processed particularly advantageously in the form of a blister foil or blister pack, in particular for pharmaceutical products, and without the problems arising with conventional multilayer systems: delamination or peel at layer interfaces. The multilayer foil here can be thermoformed very effectively by commonly encountered thermoforming molds. As can be demonstrated using microtome sections, the integrity of the composite is retained in the process. The thermoformed foil has very good transparency and stability together with excellent barrier properties.

The film thicknesses of each layer of the materials described can be selected as desired as a function of requirements. The thickness of the individual (sub)layers is preferably below approximately 100 μm after production. The functionality of the layers, e.g. the capacity of the oxygen absorber, can be adjusted within certain limits by way of the layer thickness. It is preferable to produce an outer-layer thickness prior to thermoforming of from 20 to 200 μm, in particular a (PE) layer of from 30 to 150 μm inclusive of adhesion promoter. It is preferable to set a gas-barrier thickness of from 0 to 80 μm, particularly preferably from 5 to 70 μm. The adhesion-promoter layer (AP) between gas barrier and oxygen absorber comprises from 3 to 20 μm, and between oxygen absorber and contact layer on the contents side comprises from 0 to 20 μm, in particular from 5 to 15 μm. The absorber layer should amount to from 5 to 100 μm, preferably from 5 to 70 μm, and the thickness of the contact layer (outer layer) on the side of the packaging material amounts to from 0 to 100 μm, in particular from 10 to 80 μm.

In preferred embodiments of the present invention, the packaging material comprises one of the following layer sequences.
Alternative 1: PE/adhesion promoter/EVOH/adhesion promoter/-absorber/PE
Alternative 2: PE/adhesion promoter/EVOH/adhesion promoter/-absorber/adhesion promoter/PVC
Alternative 3: PE/adhesion promoter/EVOH/ adhesion promoter/-absorber/adhesion promoter/PP

In the above alternatives, the presence of the adhesion promoter between the (oxygen)-absorber layer and the outer layer or outer foil composed of PVC, PE, or PP is merely optional. It is preferable that the inventive process uses no adhesion-promoter layer, and this is particularly the case when an outer layer is composed of PVC.

Another aspect of the present invention also provides a process for production of composite foils as mentioned above.

A plurality of materials which adhere poorly to one another have to be processed to give a composite system, in order to produce a foil which is thermoformable for the packaging of sensitive products. Suitable processes for production of layers of plastics of similar or dissimilar type are known to the person skilled in the art and can be used for production of the layers described above (p. 246 et seq.), Kunststoff-Taschenbuch [Plastics handbook], Saechtling, 26th edition, Hanser Verlag). The distinction is generally made between coextrusion processes and lamination or coating processes. By way of example, extrusion systems with at most from 5 to 7 extruders, or laminating systems with dryer can be used. In the extrusion of foils, blown-film extrusion and cast-film extrusion have been established for many years and are in principle suitable for the processing of almost all thermoplastics (see by way of example: “Folienextrusion” [Extrusion of foils] in VDI Düsseldorf, 2003, “Kunststofftechnik” [Plastics technology], ISBN 3-18-234251-7, particularly pages 69-74).

This coextrusion process produces foils whose properties cannot be achieved by a single plastic.

In the coextrusion process, various polymers are melted in extruders, and the resultant polymer strands are combined in the adapter. In the cast-film process, the plastics melt is processed by way of a wide discharge die and downstream polishing stack to give the composite foil. The foil is preferably monoaxially oriented after discharge from the die. In contrast, in the blown-film process the plastics melt is processed using cooling-air rings to give a film bubble, which after cooling is spatially fixed, and is collapsed and wound up by way of a winder. The foil is preferably biaxially oriented, and this affects the mechanical properties of the foil. In the case of poor adhesion of the layers, the durable composite has to be produced with intermediate layers on adhesion promoters. The film thicknesses obtained can vary from 10 to 500 μm.

In the case of the laminating process, at least two sheet materials (foils) are durably joined over the entire surface. The result obtained is composite materials, e.g. composite foils. To this end, a dispersion or lamination adhesive is applied between the materials to be bonded and the materials are combined in a laminator. In order to improve adhesion, the materials to be bonded are pretreated (e.g. corona-treated) as a function of the intended application. To harden the adhesives, the composite is introduced into a drying process or a UV-curing process. The layer thicknesses of laminated films vary from 60 to 600 μm.

Generation of sufficient adhesion between chemically different materials with film thicknesses below 100 μm is not a trivial matter. This applies particularly in cases in which the multilayer foil produced via coextrusion or lamination is intended to be thermoformed in a further processing step.

When the inventive composite foil is produced, at least one gas-barrier layer is incorporated in the structure. The adhesion of this layer is achieved with the aid of adhesion promoters, in particular via the use of anhydride-functionalized adhesion-promoter polymers.

The structure of the composite foil comprises at least one oxygen-absorber layer, with at least one oxygen absorber.

The current prior art resorts to adhesion promoters for the durable bonding of incompatible outer layers or contact layers, e.g. PVC, and the conventional sealing media, such as the non-polar polyolefins. These composites with PVC can generally be produced by, in a first processing step, using coextrusion to produce the adjoining layers with adhesion promoter. The PVC contact layer is generally applied to the composite in a second processing step via-lamination with lamination adhesives or lamination resin.

Surprisingly, it has now been found that in one preferred embodiment, in the case of the inventive multilayer systems, extrusion coating without adhesion promoter can be used in one operation to bond the PVC layer fed from the roll or the polyolefin layers f) with the adjoining coextruded layer e). The plastics melt of the coextrusion process preferably flows from a flat-film die downstream of the extruder and makes contact with the substrate web introduced. The materials preferably meet in a nip. In this procedure, the polishing stack and the pressure roll were heated. The counter-rotating rolls press the melt onto the substrate web and bond the two materials to one another under pressure. In this case, counter-rotating rolls press the melt onto the substrate web and bond the multilayer system under a pressure of, for example, about 4 bar.

Another aspect of the present invention therefore provides a process for production of a multilayer material, of a thermoformable foil, or of a blister pack, as described or claimed herein, comprising the following steps:
a) provision of a gas-barrier layer based on EVOH;
b) provision of an adhesion-promoter layer based on at least one anhydride-modified polymer;
c) provision of an oxygen-absorber layer based on at least one polymeric, non-particulate oxygen absorber;
d) bonding of or application of the gas-barrier layer, the adhesion-promoter layers, and the oxygen-absorber layer to one another.

Another aspect of the present invention provides a process for production of a multilayer material or packaging material as defined herein, where the multilayer foil with the layers a) to
e) is produced in only one processing step via coextrusion. It is preferable that, if the layer f) adjoining the layer e) is based on a polyolefin, the layer f) too is coextruded in the same processing step, via joint coextrusion.

If the layer f) is based on polyvinyl chloride (PVC), it can, surprisingly, be applied in the same processing step with the coextrusion of the layers a) to e) via extrusion coating, i.e. without use of adhesion promoters. This also applies to the use of foils composed of polyolefins.

Surprisingly, for example, in one preferred embodiment of the invention, when PVC is used as contact layer on the side of the packaging material, it is possible to apply a relatively low-cost, calendered PVC foil via a combination of coextrusion (PE-AP-EVOH-AP-absorber) and extrusion coating (PVC) in one processing step.

In another preferred embodiment of the invention, using PE as contact layer on the side of the packaging material of the multilayer foil (=the packaging material), the composite foil can be produced via coextrusion of the layers PE-AP-gas barrier-AP-absorber-PE. The multilayer foil can be produced via coextrusion in one processing step particularly by using, as AP, the same anhydride-modified grades of polyolefin, these having processing properties comparable with the layers of the multilayer system. However, production in combination with extrusion coating of an introduced PE foil is also possible.

Surprisingly, in another preferred embodiment of the invention, using PP as contact layer on the side of the packaging material, it is possible to apply a low-cost BOPP foil via a combination of coextrusion and extrusion coating in one processing step.

The examples below show that, surprisingly, it has been found possible to bond particularly polyolefins, such as PE or PP, and PVC, in one processing step with high-barrier materials to give thermoformable, oxygen-absorbing high-barrier materials, in particular when using anhydride-functionalized AP polymers. By way of example, a flat-film system from Diamant, composed of three single-screw extruders and of a PVC foil feed or polyolefin foil feed, or else the flat-film system from Dr. Collin GmbH (5-layer coextrusion box, Chill-Roll CR 136/350), composed of 4 single-screw extruders and of a PVC foil feed or polyolefin foil feed, was used to produce the multilayer packaging materials.

The results of oxygen-absorption measurement on the finished inventive multilayer foil show that UV activation of the absorber system used can take place via the contact layer on the contents side, the dose required for activation here being only very low (e.g. from 0.5 to 1.5 J/cm²).

Surprisingly, it has been found possible to activate the oxygen absorbers from both sides of the multilayer composite.

Surprising advantages of the inventive packaging material with respect to the packaging material application are also found in the examples below.

For example, they show that the foils underlying the invention can protect products from oxygen irrespective of humidity. Furthermore it was possible to reduce oxygen content within a period of from 2 to 7 days, starting from atmospheric oxygen content, to below 2% of oxygen in the measurement cell at very low humidity, preferably <50% r.h., particularly <25% r.h. Oxygen transmission prior to irradiation is a measure of the atmospheric oxygen barrier during storage of the packaging, and, at from 0.5 to 0.03 cm³ O₂/m² d bar, is better than that of commonly encountered high-oxygen-barrier materials (>1 cm³ O₂/m² d bar).

After oxygen scavenging, neither any oxidation products nor any migrating cleavage products could be detected by gas chromatography. Transparent foils were achieved corresponding to the esthetic requirements of the pharmaceutical industry, and exhibited what is known as the “pop effect” after thermoforming. The preferred adhesion promoters permit production of the barrier composite. The contact layer composed of polymers such as PVC, or polyolefins, such as PE/PP on the side of the packaging material can be achieved by means of extrusion coating. This greatly simplifies FDA approval.

A further aspect of the invention provides a thermoformable foil produced from a material which comprises an inventive multilayer material. Not only the multilayer material but also the foil can generally have any desired size and shape. It is possible to produce and use any desired dimensions as a function of application sector. In many cases, the inventive multilayer material is produced in long webs.

In one preferred embodiment, the thermoformable foil is sealable with a metal foil, such as an aluminum foil, onto which a sealing medium has been-applied.

Another aspect of the invention provides a blister pack, comprising a multilayer material as claimed in the invention, in particular in thermoformed form, and also, if appropriate, a metal foil sealed therewith.

Another aspect of the invention provides the use of the inventive material or of the foil or blister pack. One preferred use concerns the use in a gas-barrier layer whose oxygen transmission is <1 cm³/m² d bar, in particulars 0.1 cm³/m² d bar.

An important inventive use provides in a general sense the packaging of pharmaceutical and non-pharmaceutical products. By way of example, preferred uses comprise reduction of oxygen concentration in a container or in packaging for a product which is preferably oxygen-sensitive, or the packaging of a solid, liquid, or gaseous product. The product can involve a pharmaceutical product, in particular in solid form, e.g. a tablet, or capsule, a dragrée, a powder, or a suppository, or else a liquid pharmaceutical product. By way of example, the packaging can involve overwrapping of a plurality of packaging units for (pharmaceutical) products. By way of example, the packaging can take the form of a bag, a bottle, a tray, a single-dose pack, a blister pack, or a container.

However, the product to be packaged can equally well involve a chemical used for non-pharmaceutical purposes, a food or drink, engineering components, in particular electrical-engineering and electronic components, cosmetics, products produced by bio-technology and used for non-pharmaceutical purposes, in particular enzymes or proteins, or the like.

### EXAMPLES

The first inventive examples given below describe in detail the particularly high barrier with respect to CO₂ and oxygen when inventive adhesion promoters are used. The layer sequence (from the outside to the contents side) is in each case briefly stated in the heading of the examples.

### Comparative Example 1

### (PE/AP/EVOH/absorber/PE)

A 75 μm PE foil of pharmaceutical quality (corona-treated) was extrusion-coated on a Fraunhofer IVV (Freising) flat-film plant, composed of three single-screw extruders (45/30/30 mm diameter, processing length 32D/28D/28D, 180° C.) with polishing stack from Diamant, with a layer of 30 μm of absorber (OSP™ System, Chevron Phillips Chemical Company), 50 μm of EVOH (Eval, Mitsui), 8 μm of adhesion promoter (Admer PE-type grade, Mitsui), and 100 μm of PE (LDPE, Basell), the take-off speed used being 2 m/min.

### Inventive Example 1

### (PE/AP/EVOH/AP/absorber/PE)

A 20 μm PE foil (LDPE, Basell) of pharmaceutical quality was extrusion-coated on a coextrusion system from Dr. Collin GmbH, composed of two single-screw extruders with diameter 30 mm, processing length from 25 to 30D, and two single-screw extruders with diameter 25 mm, processing length from 25 to 30D, and feed block system for from 2 to 9 layers with type 136 calender unit with a layer of 30 μm of absorber (OSP™ Systems, Chevron Phillips Chemical Company), 10 μm of adhesion promoter (Admer PE-type grade, Mitsui or Bynel® series 4200, DuPont), 50 μm of EVOH (Eval, Mitsui), 10 μm of adhesion promoter (Admer PE-type grade, Mitsui) and 100 μm of PE (LDPE, Basell), at from 180 to 210° C., the take-off speed used being from 5 to 6 m/min. Comparable results (see table 1) were obtained using Bynel® series 4200, DuPont.

The gas transmission (O₂) of the composite systems was tested to DIN 53380, part 3, using a MOCON (Modern Control Inc.) at 23° C. The results for oxygen transmission (OTR in cm³O₂/m² d bar) have been collated in table 1. Gas transmission for CO₂ was tested using the manometric test method to DIN 53380 P2 at 23° C. Similar results were obtained when inventive example 1 was repeated on the flat-film system from comparative example 1.

TABLE 1
Barrier composite with PE contact layer on contents
side

| | | Layer | O₂ | CO₂ |
|---|---|---|---|---|
| | | thickness | (cm³/m² d | (cm³/m² d |
| Example | Layer structure | AP (μm) | bar) | bar |
| CE 1 | PE/AP/EVOH/ | 8 | >1.5 | >7 |
| | absorber/PE | | | |
| IE 1 | PE/AP/EVOH/ | 20 | <0.1 | 0.2-0.3 |
| | AP/absorber/PE | | | |

CE = comparative example;
IE = inventive example

The excellent barrier values, i.e. the extremely low gas transmission of the composite foil of inventive example 1 is all the more surprising because the total gas transmission (O₂, CO₂) to be expected according to theoretical calculation of the corresponding barrier of PE/EVOH/absorber/PE or, respectively, PVC would be 0.2 cm³/m² d bar. The total permeability expected can be estimated by combining the individual permeabilities of the materials used and layer thicknesses (“Plastic Packaging Materials for Food”, O. -G. Piringer, A. L. Baner, Wiley-VCH 2000). Furthermore, the person skilled in the art is aware that the expected barrier in the composite is generally determined by the layer thickness of the barrier material. A rule of thumb for CO₂ transmission is that CO₂ transmission is about 4 times O₂ transmission. When inventive example 1 was repeated with the exception that the thickness of each of the adhesion-promoter layers was 2 μm, considerably higher gas transmissions (O₂, CO₂) were observed.

### Inventive Example 2

### (PE/AP/EVOH/AP/absorber/PVC)

A 50 μm PVC foil (corona-treated) of pharmaceutical quality was extrusion-coated on a coextrusion system from Dr. Collin GmbH (cf. above) with a layer of 30 μm of absorber (OSP™Systems, Chevron Phillips Chemical Company), 10 μm of adhesion promoter (Admer PE-type grade, Mitsui or Bynel® series 4200, DuPont), 50 μm of EVOH (Eval, Mitsui), 10 μm of adhesion promoter (Admer PE-type grade, Mitsui or Bynel® series.4200, DuPont) and 100 μm of PE (LDPE, Basell), at from 180 to 210° C., the take-off speed used being from 5 to 6 m/min.

### Inventive Example 3

### (PE/AP/EVOH/AP/absorber/LA/PP)

A 50 μm PVC foil (corona-treated) of pharmaceutical quality was extrusion-coated on a coextrusion system from Dr. Collin GmbH (cf. above) with a layer of 30 μm of absorber (OSP™ Systems, Chevron Phillips Chemical Company), 10 μm of adhesion promoter (Bynel® series 4200, DuPont), 50 μm of EVOH (Eval, Mitsui), 10 μm of adhesion promoter (Bynel® series 4200, DuPont) and 100 μm of PE (LDPE, Basell), at from 180 to 210° C., the take-off speed used being from 5 to 6 m/min. In a second processing step, the 50 μm PVC foil was removed on the Fraunhofer IVw lamination system, and the coextrusion foil was laminated with a 100 μm PP foil and lamination adhesive (Lamal grade, Rohm and Haas). For hardening of the lamination adhesive, the foil roll was wound in aluminum foil, heat-sealed under nitrogen, and stored at 23° C. for 7 days.

Oxygen transmission of the composite system was tested to DIN 53380, part 3, using a MOCON (Modern Control Inc.) at 23° C. The results for oxygen transmission and CO₂ transmission (in cm³/m² d bar) have been collated in table 2.

TABLE 2
Barrier composite with PVC contact layer on contents
side

| | | Layer | O₂ | CO₂ |
|---|---|---|---|---|
| Inventive | | thickness | (cm³/m² d | (cm³/m² d |
| example | Layer structure | AP (μm) | bar) | bar |
| IE 2 | PE/AP/EVOH / | 20 | 0.03 | 0.2-0.3 |
| | AP/absorber/PVC | | | |
| IE 3 | PE/AP/EVOH/ | 30 | <0.1 | 0.2-0.3 |
| | AP/absorber/ | | | |
| | LA/PP | | | |

The results in table 2 above demonstrate the excellent O₂ and CO₂ barrier of the inventive materials. The experimental results also demonstrated (not shown) that the inventive coextrusion process can achieve very good adhesion between a PVC foil and the absorber foil, even without lamination adhesives or adhesion promoters, and that this adhesion also leads to particularly good bond strength in the composite foil overall and to a further increase in the gas barrier.

Production of Inventive Foils via (Low-cost) Coextrusion

Inventive examples for the production of the inventive polymer foils, in particular for the foils with PVC contact layer, are given below. Production of the multilayer packaging materials used a flat-film system from Diamant (DE 45/30/30/800), composed of three single-screw extruders and of a PVC foil feed or polyolefin foil feed, or else a flat-film system from Dr. Collin GmbH (5-layer coextrusion box, Chill-Roll CR 136/350), composed of four single-screw extruders and of a PVC foil feed or polyolefin foil feed. Blown-film systems which can produce multilayer composite-materials (multilayer materials) at low cost in one step are likewise suitable. A blown-film system from Kiefel AG, DE was therefore used, composed of three single-screw extruders and blown-film die.

### Comparative Example 2

### (PVC/O₂ Absorber/Lamination Adhesives (LA)/PVC); Standard PVC-lamination Process

A 150 μm PVC foil of pharmaceutical quality was extrusion-coated on a Fraunhofer IVV (Freising) flat-film system with a layer of 100 μm of absorber (OSP™ Systems, Chevron Phillips Chemical Company), the take-off speed used being 3 m/min. In a second step, the absorber side was laminated with a 20 μm PVC foil and lamination adhesive (layer thickness: 8 μm)(Lamal grade, Rohm and Haas) on the lamination system of the Fraunhofer IVV. For hardening of the lamination adhesive, the foil roll was wound in aluminum foil, heat-sealed under nitrogen, and stored at 23° C. for 7 days. The surface energy of the PVC foil was 38 dynes, and the surface energy of the absorber layer was 36 dynes.

### Inventive Example 4

### (PE/AP/EVOH/AP/Absorber/LA/PVC)

A 50 μm PVC foil (corona-treated) of pharmaceutical quality was extrusion-coated on a coextrusion system from Dr. Collin GmbH with a layer of 30 μm of absorber (OSP™ Systems, Chevron Phillips Chemical Company), 10 μm of adhesion promoter (Admer PE-type grade, Mitsui), 50 μm of EVOH (Eval, Mitsui), 10 μm of adhesion promoter (Admer PE-type grade, Mitsui) and 100 μm of PE (LDPE, Basell), at from 180 to 210° C., the take-off speed used being from 5 to 6 m/min. In a second processing step, the 50 μm PVC foil was removed on the lamination system of the Fraunhofer IVV, and the coextrusion foil was laminated with a 50 μm corona-treated PVC foil and lamination adhesive (Lamal grade, Rohm and Haas). For hardening of the lamination adhesive, the foil roll was wound in-aluminum foil, heat-sealed under nitrogen, and stored at 5° C. for 7 days. When Bynel® series 4200, DuPont was used as adhesion promoter, comparable results were obtained.

### Inventive Example 5

### (PE/AP/EVOH/AP/absorber/PE)

The PE/AP/EVOH composite previously produced via coextrusion was extrusion-coated with a layer of 10 μm of PE adhesion promoter (Bynel series, DuPont), of 20 μm of absorber (OSP™ Systems, Chevron Phillips Chemical Company) and 30 μm of PE (Lupolen, Basell) on the flat-film system of the Fraunhofer IVV (Freising), the take-off speed used being 2 m/min.

### Inventive Example 6

### (PE/AP/EVOH/AP/PE/absorber/PE)

A foil composed of a layer of 100 μm of PE (LDPE, Basell), 10 μm of PE adhesion promoter (Bynel series, DuPont), 50 μm of EVOH (Eval, Mitsui), 10 μm of PE adhesion promoter (Bynel series, DuPont), 20 μm of PE (Lupolen, Basell), 20 μm of absorber (OSP™ Systems, Chevron Phillips Chemical Company) and 30 μm of PE (Lupolen, Basell) was coextruded on the flat-film system of the Fraunhofer IVV (Freising), the take-off speed used being 2 m/min.

### Inventive Example 9

### (PE/AP/PA/EVOH/AP/absorber/PE)

A blister foil of pharmaceutical quality composed of a layer of 50 μm of PE (LDPE, Basell), 30 μm of absorber (OSP™ Systems, Chevron Phillips Chemical Company), 10 μm of-adhesion promoter (Admer PE-type grade, Bynel series, DuPont), 30 μm of EVOH (EvalF101B, Mitsui), 20 μm of PA (Pharmaqualität), 10 μm of adhesion promoter (Admer PE-type grade, Bynel series, DuPont) and 50 μm of PE (Lupolen, Basell) was coextruded on the coextrusion system from Kiefel AG (cf. above) at from 180 to 210° C., the take-off speed used being 30 m/min.

The results of bond strength measurement have been collated in table 3 below. For the bond strength tests, separation of the specimens was initiated manually. The tests were carried out on an electromechanical universal testing machine, the longitudinal and transverse separation velocity used being 100 mm/min. The angle of separation was 90. As is well known to the person skilled in the art, adhesion for composites suitable for thermoforming is to be >1.5 N/15 mm.

| | | | Transverse bond |
|---|---|---|---|
| Inventive | | Longitudinal bond | strength |
| example | Composite | strength (N/15 mm) | (N/15 mm) |
| IE 1 | PE/AP/EVOH/ | impossible to measure without | |
| | AP/absorber/ | destruction | |
| | PE | | |
| IE 2 | PE/AP/EVOH/ | 2.2 | 3.6 |
| | AP/absorber/ | | |
| | PVC | | |
| IE 5 | PE/AP/EVOH// | 1.5-2.0 | — (n.d.) |
| | AP/O₂— | | |
| | absorber/PE | | |

| | | |
|---|---|---|
| IE 6 | PE/AP/EVOH/ | impossible to measure without |
| | AP/PE/ | destruction |
| | absorber/PE | |
| IE 9 | PE/AP/ | impossible to measure without |
| | PA/EVOH/AP/ | destruction |
| | absorber/PE | |

(n.d.) = not determined

Preferred Composite Foils for Active Oxygen Scavenging

Inventive examples are presented below which provide evidence of the preferred use of the inventive composite foils for active oxygen scavenging. Processes described above were used to produce the foils. In order to activate oxygen absorption, the foil was irradiated using a -VA dryer system from Hönle (UVA-Print 200; radiation dose 1.0-2.5 J/cm²). Oxygen absorption by the films was tested using a Clark electrode after W initiation at 23° C., 50-60% relative humidity (r.h.), and at 21% oxygen concentration in the test cell. The results demonstrate that oxygen absorption can be activated from both sides of the multilayer composites. In particular, initiation can be achieved via a UW-absorbent PVC layer using a relatively small radiation dose of 1.0 J/cm². Unless otherwise mentioned, initiation from the two sides of the composite foil gave comparable absorption values.

### Comparative Example 3

### (PE/absorber/PE)

A 27 μm LDPE foil (Lupolen, Basell) of pharmaceutical quality was coextruded on the flat-film system of the Fraunhofer IVV (Freising) with a layer of 25 μm of LDPE, the take-off speed used being 3.8 m/min.

| | Experimental time | Oxygen absorption |
|---|---|---|
| Composite | [d] | [ml O₂/g absorber] |
| LDPE/absorber/ | 1 | 23 |
| LDPE | | |
| | 2 | 45 |
| | 5 | 54 |
| | 10 | 56 |
| | 20 | 59 |

### Inventive Example 7

### (PE-AP/EVOH/absorber-AP/PVC)

A 50 μm PVC foil of pharmaceutical quality was extrusion-coated on the flat-film system of the Fraunhofer IVV (Freising) with a layer of 50 μm of absorber/adhesion promoter blend (OSP™ Systems, Chevron Phillips Chemical Company, Admer, Mitsui, 3:1), 35 μm of EVOH (Eval, Mitsui) and 80 μm of PE/adhesion promoter blend (Lupolen, Basell; Admer, Mitsui, 1:1), the take-off speed used being 2 m/min.

| | Experimental time | Oxygen absorption |
|---|---|---|
| Specimen | [d] | [ml O₂/g absorber] |
| Activated from PVC | 1 | 1.5 |
| side | | |
| | 2 | 2.0 |
| | 5 | 10.1 |
| | 10 | 29.8 |
| Activated from PE | 1 | 13.2 |
| side | | |
| | 2 | 22.3 |
| | 5 | 31.5 |
| | 10 | 45.4 |

### Inventive Example 3

### (PE/AP/EVOH/AP/absorber/LA/PP)

The production process has been described above.

| | Experimental time | Oxygen absorption |
|---|---|---|
| Specimen | [d] | [ml O₂/g absorber] |
| PE/AP/EVOH/AP/ | 1 | 2 |
| absorber/LA/PP | | |
| | 2 | 3 |
| | 5 | 16 |
| | 10 | 34 |

### Inventive Example 5

### (PE/AP/EVOH//AP/O₂ absorber/PE)

The production process has been described above.

| | Experimental time | Oxygen absorption |
|---|---|---|
| Specimen | [d] | [ml O₂/g absorber] |
| PE/AP/EVOH/AP// | 1 | 3.0 |
| absorber/PE | | |
| | 2 | 4.8 |
| | 3 | 7.5 |
| | 5 | 12.1 |
| | 10 | 13.0 |

### Inventive Example 8

### (PE/AP/EVOH/LA/PE/absorber/PE)

A foil composed of a layer of 100 μm of PE (LDPE, Basell), 10 μm of PE adhesion promoter (Bynel series, DuPont), 50 μm of EVOH (Eval, Mitsui) and a foil composed of 20 μm of PE (Lupolen, Basell), 20 Am of absorber (OSP™ Systems, Chevron Phillips Chemical Company), and 30 μm of PE (Lupolen, Basell) was coextruded on the flat-film system of the Fraunhofer IVV (Freising), the take-off speed used being 2 m/min. The two coextruded composites were laminated on the lamination system of the Fraunhofer IVV with lamination adhesive (2-component system from Rohm and Haas). For hardening of the lamination adhesive, the foil roll was wound in aluminum foil, heat-sealed under nitrogen, and stored at 23° C. for 7 days.

| | Experimental time | Oxygen absorption |
|---|---|---|
| Specimen | [d] | [ml O₂/g absorber] |
| PE/AP/EVOH/LA/ | 1 | 0.3 |
| PE/absorber/PE | | |
| | 2 | 14.2 |
| | 5 | 30.1 |
| | 10 | 53.2 |
| | 14 | 59.6 |

### Inventive Example 6

### (PE/AP/EVOH/AP/PE/absorber/PE)

The production process has been described above.

A foil composed of a layer of 100 μm of PE (LDPE, Basell), 10 μm of PE adhesion promoter (Bynel series, DuPont), 50 μm of EVOH (Eval, Mitsui), 10 μm of PE adhesion promoter (Bynel series, DuPont), 20 μm of PE (Lupolen, Basell), 20 μm of absorber (OSP™ Systems, Chevron Phillips Chemical Company), and 30 μm of PE (Lupolen, Basell) was coextruded on the flat-film system of the Fraunhofer IVV (Freising), the take-off speed used being 2 m/min.

| | | Oxygen absorption |
|---|---|---|
| Specimen | Experimental time [d] | [ml O₂/g absorber] |
| PE/AP/EVOH/AP/ | 1 | 0.3 |
| PE/absorber/PE | | |
| | 2 | 13.01 |
| | 5 | 29.5 |
| | 10 | 55.0 |
| | 14 | 58.5 |

1. A multilayer material, preferably for use with oxygen-sensitive products, comprising at least the following sequence of layers:
a) an adhesion promoter layer comprising at least one anhydride-modified polymer;
b) a gas-barrier layer comprising EVOH;
c) a second adhesion-promoter layer comprising at least one anhydride-modified polymer;
d) an oxygen-absorber layer comprising at least one polymeric, non-particulate oxygen absorber, wherein the second adhesion-promoter layer is between the gas-barrier layer and the oxygen-absorber layer.

2. The multilayer material as claimed in claim 1, characterized in that the oxygen-absorber layer comprises at least one polymeric ethylenically unsaturated oxygen absorber.

3. The multilayer material as claimed in claim 1, characterized in that the thickness of each of the adhesion-promoter layers as claimed in claim 1 a) and c) is at least approximately 5 μm.

4. The multilayer material as claimed in claim 1, characterized in that the total thickness of the adhesion-promoter layers is at least approximately 10 μm.

5. The multilayer material as claimed in claim 1, characterized in that the total thickness of the adhesion-promoter layers is at least approximately 15 μm.

6. The multilayer material as claimed in claim 1, characterized in that the total thickness of the adhesion-promoter layers is from approximately 20 to 40 μm.

7. The multilayer material as claimed in claim 1, characterized in that the thickness of at least one adhesion-promoter layer is at least approximately 5 μm.

8. The multilayer material as claimed in claim 1, characterized in that the layer thickness of the gas-barrier layer is less than 100 μm.

9. The multilayer material as claimed in claim 1, characterized in that its oxygen transmission is ≦0.1 cm³/(m² d bar).

10. The multilayer material as claimed in claim 1, characterized in that its CO₂ transmission is <50 cm³/(m² d bar).

11. The multilayer material as claimed in claim 1, characterized in that the thickness of each of the adhesion-promoter layers is approximately the same.

12. The multilayer material as claimed in claim 1, further comprising at least one outer layer which preferably serves as a water-vapor barrier, comprising filled or unfilled polymers.

13. The multilayer material as claimed in claim 1, characterized in that the oxygen absorber is self-activating or can be activated via radiation.

14. The multilayer material as claimed in claim 1, characterized in that the oxygen absorber is activated via UV radiation and scavenges oxygen when relative humidity is less than 20% (r.h.).

15. The multilayer material as claimed in claim 1, characterized in that at least one adhesion-promoter layer comprises a mixture of an adhesion-promoter with at least one other component, where the percentage of the adhesion promoter in the mixture is less than approximately 50% by weight and more than approximately 10% by weight.

16. The multilayer material as claimed in claim 1, characterized in that at least one adhesion-promoter layer comprises more than 50% by weight of at least one adhesion promoter.

17. The multilayer material as claimed in claim 1, characterized in that at least one adhesion-promoter layer is comprised exclusively of an adhesion promoter.

18. The multilayer material as claimed in claim 16, characterized in that the adhesion promoter is selected from the group consisting of anhydride-modified polyolefins, such as polypropylene or polyethylene, and anhydride-modified ethylene copolymers, such as EVA or ethyl acrylates and mixtures thereof.

19. The multilayer material as claim in claim 16, characterized in that the adhesion promoter comprises an anhydride-modified polyolefin.

20. The multilayer material as claimed in claim 1 further comprising an external side and a contents side, characterized in that at least one adhesion-promoter layer has been arranged between the oxygen-absorber layer and the external side.

21. A multilayer material comprising at least the following sequence of layers:
a) an outer layer which serves as a water-vapor barrier comprising a filled or unfilled polymer, selected from the group consisting of polyester, polyethylene terephthalate, polyurethanes, polypropylene, polyethylene halides, PVC, PVDC, PVF, PVDF, halogen-containing copolymers, polyolefin copolymers, ethylene-vinyl acetate (EVA), liquid-crystalline polymers (LCPs), PAN, PEN, COC, and mixtures thereof;
b) an adhesion-promoter layer comprising an adhesion promoter, where the adhesion promoter is selected from the croup consisting of: ionomeric copolymers, vinyl chloride copolymers, modified ethylene-vinyl acetates, polymerizable polyesters, phenolic resins, polystyrene copolymers, anhydride-modified polymers, 2-component adhesives, single-component or two-component lamination resins, PU systems, epoxy resins; and mixtures thereof;
c) a gas-barrier layer comprising EVOH;
d) an adhesion-promoter layer comprising at least one anhydride-modified polymer; and
e) an oxygen-absorber layer comprising at least one polymeric, non-particulate oxygen absorber.

22. The multilayer material as claimed in claim 1, characterized in that it is transparent or translucent.

23. The multilayer material as claimed in claim 1, characterized in that the total thickness of the multilayer material is at least 100 μm.

24. The multilayer material as claimed in claim 13, characterized in that the oxygen absorber is activatable by UV light.

25. The multilayer material as claimed in claim 1, characterized in that the oxygen absorber is activatable from two sides of the multilayer material.

26. The multilayer material as claimed in claim 1, characterized in that the oxygen absorber is activatable by a UV light dose of from 0.5 to 2.5 J/cm².

27. A thermoformable foil, produced from the material claimed in claim 1.

28. The thermoformable foil as claimed in claim 27, characterized in that it is sealable with a metal foil.

29. A blister pack, comprising the transformable foil of claim 27, and further comprising a metal foil sealed therewith.

30. A process for production of a multilayer material for a thermoformable foil, or a blister pack, comprising the following steps:
a) preparing a gas-barrier layer comprising EVOH;
b) preparing two adhesion-promoter layers each comprising at least one anhydride-modified polymer;
c) preparing an oxygen-absorber layer comprising at least one polymeric, non-particulate oxygen absorber; and
d) bonding the gas-barrier layer, the adhesion-promoter layers, and the oxygen-absorber layer to one another, where the adhesion-promoter layers are adjoining the gas-barrier layer.

31. (canceled)

32. The process as claimed in claim 30, characterized in that the total thickness of the adhesion-promoter layers is at least 10 μm.

33. The process as claimed in claim 30, characterized in that the multilayer material is produced in one processing step by means of coextrusion or extrusion coating.

34. The process as claimed in claim 30, further comprising preparing and bonding an outer or contact layer to a side of the oxygen-absorber layer, opposite the adhesion promoter layer, wherein the outer or contact layer is produced via coextrusion or extrusion coating without use of any lamination adhesive or adhesion promoter.

35. The process as claimed in claim 34, characterized in that the composition of the outer layer or contact layer adjoining the oxygen-absorber layer is selected from the group consisting of PE, PP, or PVC and mixtures thereof.

36. The process as claimed in claim 34, characterized in that the outer or contact layer adjoining the oxygen-absorber layer comprises BOPP.

37. The process as claimed in claim 30, characterized in that the layer adjoining the oxygen-absorber layer comprises polyethylene.

38. The multilayer material as claimed in claim 21 wherein its oxygen transmission is ≦1 cm³/(m² d bar).

39. (canceled)

40. (Canceled)

41. (Canceled)

42. (Canceled)

43. (Canceled)

44. (Canceled)

45. (Canceled)

46. (Canceled)

47. The multilayer material of claim 21 further comprising an outer or contact layer adjacent to the oxygen-absorber layer with a composition selected from the group consisting of PE, PP, PVC, PVDC, and fluorinated systems and mixtures thereof.

48. The multilayer material of claim 1 wherein its CO₂ transmission is <50 cm³/(m² d bar).
